(19) United States
(12) Patent Application Publication
(10) Pub. No.: US 2015/0279228 A1
(43) Pub. Date: Oct. 1, 2015

(54) REAL MOTORBIKE-RIDING SIMULATOR

(71) Applicant: Guy François, Joseph DERICQUEBOURG, Bethonsart (FR)

(72) Inventor: Guy Francois, Joseph Dericquebourg, Bethonsart (FR)

(21) Appl. No.: 14/438,249

(22) PCT Filed: Oct. 4, 2013
(86) PCT No.: PCT/FR2013/000260

§ 371 Date: Apr. 24, 2015

(30) Foreign Application Priority Data
Oct. 26, 2012 (FR) 12/02864

(51) Int. Cl. G09B 9/058; G09B 9/042

(52) U.S. Cl. CPC G09B 9/058; G09B 9/042

(57) ABSTRACT

Device to simulate the piloting of a two-wheeled vehicle that restitutes the true sensations of driving

The present invention relates to a device that allows the sensations of riding to be felt in order to contribute to improving riding performance in complete safety; it can be used without danger by all types of drivers.

The device comprises a real two-wheeled vehicle moving over two treadmills. The vehicle is held in position on the device by a rigid support attached to the chassis of the vehicle. Different jacks control the lateral tilt and various behavioral aspects of the vehicle. The device comprises means for visualizing the route, for simulating acceleration and braking and for circulating air to complete the sensory experience.

The device according to the invention is particularly intended to improve the driving of two-wheeled vehicles but can also be used for testing equipment.

The invention relates to a device simulating the piloting of a two-wheeled vehicle that renders the true driving sensation thanks to the use of an actual vehicle. The device allows training and improving the motorcycle driving of all types and all engine power; it can be also adaptable to scooters and other alike vehicles. It allows drivers to safely exceed their usual limits in improving their individual and sporting performances. Indeed the device removes the risks of driving while leaving the driver feel the vehicle's behavior as if it was circulating on a real route. Driving errors are with no consequences, this permits a learning with no danger.

Existing devices permit to simulate moving a two-wheeled vehicle on a road displayed on a screen, but the piloting is not realistic because these devices do not restitute the actual behavior of this type of vehicle. When using an existing simulator, we do not feel acceleration and braking phenomena nor the wind effects nor reduced adhesion on wet ground because the wheels are absent of these simulators, the mass and the movements of the device on which the driver sits are not representative of an actual vehicle, the resistance to the tilt does not exist. Indeed, there is no gyroscopic effect since there is no rotating mass. Also exceptional situations such as cornering wheel slip cannot exist because the model does not have enough degrees of freedom on its support and the driver cannot use these simulators for learning but only for the fun and will be unable to feel the pleasure of real motorcycle use.

The inventive device overcomes these drawbacks by the restitution of the real behavior of a vehicle thereby improving learning and performances piloting with no danger. These safety conditions afforded by the device with respect to the driving in normal traffic conditions constitute an important enhancement because it can reduce the rate of individual accidents resulting from steering errors.

According to a first characteristic, the device comprises a real vehicle which evolves on two separate treadmills, one for the front wheel and one for the rear wheel. The rear treadmill being driven by the rear wheel of the vehicle and the front wheel of the vehicle is driven at the same rotational speed by the front treadmill. The latter further having the ability to track movements of the direction of the vehicle's handlebar. It permits to reproduce indoor the actual behavior the vehicle would have on an outer path in normal driving situation but also in exceptional situation.

According to a second characteristic, the treadmills of the device can achieve the requirements of actual velocities for the actual two-wheeled vehicles travelling on road and on race track, they also allow measuring in real time the vertical pressure exerted by each wheel on the treadmills during taxiing.

According to a third characteristic, the distance between the front treadmill and the rear treadmill is adjustable to adapt to the wheelbase of different usable vehicles, also the treadmills can be easily replaced to change the conditions of wheel adhesion to enable reproduction of different traffic conditions linked to the weather.

According to a fourth characteristic, the vehicle is held on the device by a rigid support attached to the chassis of the vehicle. Thereby the vehicle retains its position on the treadmills during driving. The holder is provided with multiple degrees of freedom to authorize the tilting of the vehicle required to cornering until a maximum tilt with respect to the vertical. This limit is predetermined and stationary but can be changed if necessary, this limit assures the impossibility of real lateral fall for the vehicle.

According to a fifth characteristic, the vehicle tilt can be easily constraints at values below the maximum limit. By way of non-limiting example, to permit a driving mode with an imposed tilt amplitude.

According to a sixth characteristic, a second degree of freedom of the support enables restitution of exceptional behaviors of the vehicle, By way of non-limiting example; the support allows wheel slip in curve due to loss of adhesion. The support limits the amplitude of all vehicle movements to avoid the fall of the vehicle and its driver.

According to a seventh characteristic, the device can limit the vehicle's behavior to a nominal driving mode preventing exceptional movements. In this case the amplitude of movements of the vehicle is attenuated so that the drivers do not undergo the driving error consequences which in actual situation would be sanctioned by a fall. By way of non-limiting example, this mode can be used in a learning phase with simplified control of the vehicle when starting a driving training.

According to an eighth characteristic, the device comprises display means for both the road and the offroad whose size and positions permit stimulating the driver gaze and on which the movement path is controlled in real time by the trajectory of the vehicle regardless of the simulation settings and the visualization mode chosen. The ideal trajectory display can also be viewed during simulations.

According to a ninth characteristic, the device comprises a chest protector worn by the driver of the vehicle to restitute the acceleration thrills and braking. The driver feels immediate effects of its actions on the controls of the vehicle.

According to a tenth characteristic, the device comprises lateral wind simulation means, front and rear in order to be at the nearest possible to the driving external conditions.

According to an eleventh characteristic, the device comprises security elements with automatic triggering, but also manually controllable from a control desk to ensure the safety of the conductor and surrounding elements in case of emergency situation. Said components enable stopping the vehicle engine and stop the rotation of the rotating elements of both device and vehicle. Furthermore the chest protector mentioned in the ninth feature prevents the driver to be ejected in the event of inadvertent movement of the vehicle.

According particular embodiments the device may allow interchangeability of the vehicle to meet various user needs. Once the vehicle is installed on the device, the latter can be used as it would be on a true road but without causing absolute displacement in the space thanks to the 2 treadmills located under the wheels and thanks to the central support which holds in place the vehicle in semi-rigid way.

The tilting range can be constraint for performing certain driving exercises; natural and exceptional movements of the vehicle used are possible but can be limited to avoid any fall. To allow all these types of vehicle movement, the central support can be attached to the central body of the device thanks to some jacks that provide a capacity of movement in the 3 dimensions. Visualization screens may present to the driver the move trajectory calculated from the path of the vehicle. This path may be virtual or real, road or offroad, (open or closed circuit) depending on simulations selected. The drivers can be subjected to acceleration and braking forces that they generate themselves with the vehicle and they can be subjected to the air flow generated from the speed, in addition a predetermined wind force can be added and all of this in different adhesion conditions corresponding to real circumstances.

The device can be controlled by a control console that can include the functions: Device startup with init test, simulation sequence start, restricted simulation start and device stopping. The control desk can control in real time the running of all events in order to automatically stop the simulation sequence in case of emergency: stopping the engine and rotating parts on the device. The stop can also be caused manually from the control desk by the person who manages the device during the simulation.

The drawings illustrate the invention:

Drawing 1 is in side view the base version of the invention without the protection floors (1) and (2).

Drawing 2 is a partial top view without vehicle, variant of the invention with 2 lateral treadmills.

With reference to these drawings, the device comprises a fixed floor (1) for easy access to the vehicle and covers the device structure. A floor (2) integral with the part (3c) from vehicle support completes the fixed floor (1). Vehicle access is made via the ramp (24).

2 treadmills (4) and (5) supporting the vehicle are fixed on a main frame (6) which is also the attachment point for the jack (7) controllable in position, these latter are fixing the vehicle support (3c) in semi-rigid way.

The vehicle support is built in three parts (3a), (3b) and (3c) allowing interchangeability of the vehicle mounting system as it differs depending on the type of vehicle used.

The elements (3a) and (3b) are limited in their tilting movement by a jack (8) to allow the movement restrictions during simulations constraint. The absolute limit of the vehicle tilt is restricted by the design of the part (3c) of the support using an axis (9) inserted into the piece (3b) and which supports on the piece (3c).

The treadmill (5) below the front wheel is steerable and is controlled in position following the direction of the handlebar of the vehicle; said command uses an angle sensor for measuring in real time the position of the handlebar. The rotational speed of the treadmill (5) is controlled to the vehicle speed by an electric motor and the speed sensor installed on the rear treadmill (4). The setting of belt tension for the 2 treadmills (4) and (5) is performed using a mechanical sliding device and a screw-nut system.

The visualization (10) can stimulate the entire field of vision of the driver. The chest protector of the driver (11) uses front and rear lines (12) et (13) for generating acceleration sensations and braking felt by the drivers and to assure their safety in case of inadvertent movements of the vehicle by using instantaneous locking means. 2 lines (12) extend from the rear face of the chest protector (11) for joining their control box (14) and 2 lines (13) extend from the front face of the chest protector through the vehicle steering column and return to the rear of the vehicle in the control box (14).

The air effect for the wind is implemented by several fans with regulated speed (15) positioned around the device and mounted on the main frame (6). The speed of the fans (15) is calculated from the speed of vehicle and versus simulation conditions. The different adhesion conditions can be made by tensioning means on the treadmills (4) and (5) since they permit the rapid change of the belt.

The security elements are made as follows:

An actuator (16) acting on the emergency stop of the vehicle thereby stopping the engine in the event of a dangerous situation. The actuator can be engaged by the emergency stop (17) of the control console (18) or automatically if the device control system detects abnormal operating conditions. The rear wheel is braked by an actuator (19) acting on the vehicle's brake. The treadmills (4) and (5) are stopped by stopping the drive motor of the front treadmill (5) and by braking of the rear treadmill (4). The vehicle is automatically brought back to vertical position and the pilot is retained in position by the chest protector (11) like a safety belt retains a car driver.

The control console (18) is constituted by a computer with a screen and input-output boards for acquiring the measurements from the sensors of the device, to perform the necessary calculations, operate actuators and control elements. The screen of the control console (18) manages the device in all phases of operation. The specific push button (17) provides emergency stop function of the device and a key switch (20) locks the use of the device by unauthorized persons. The connection between the control console (18) and control-command elements of the device can be wired or wireless according to need.

A radio communication system enables a bidirectional link between the vehicle driver and one or more parties located at the control console (18).

A system for venting exhaust vapors (21) is installed on the vehicle exhaust tubes to avoid polluting of the room.

Noise protection elements (22) are fixed around the device in order to respect the acoustic comfort of the users and the direct environment. Of same, security elements (23) are positioned around the device to assure the protection of people moving nearby.

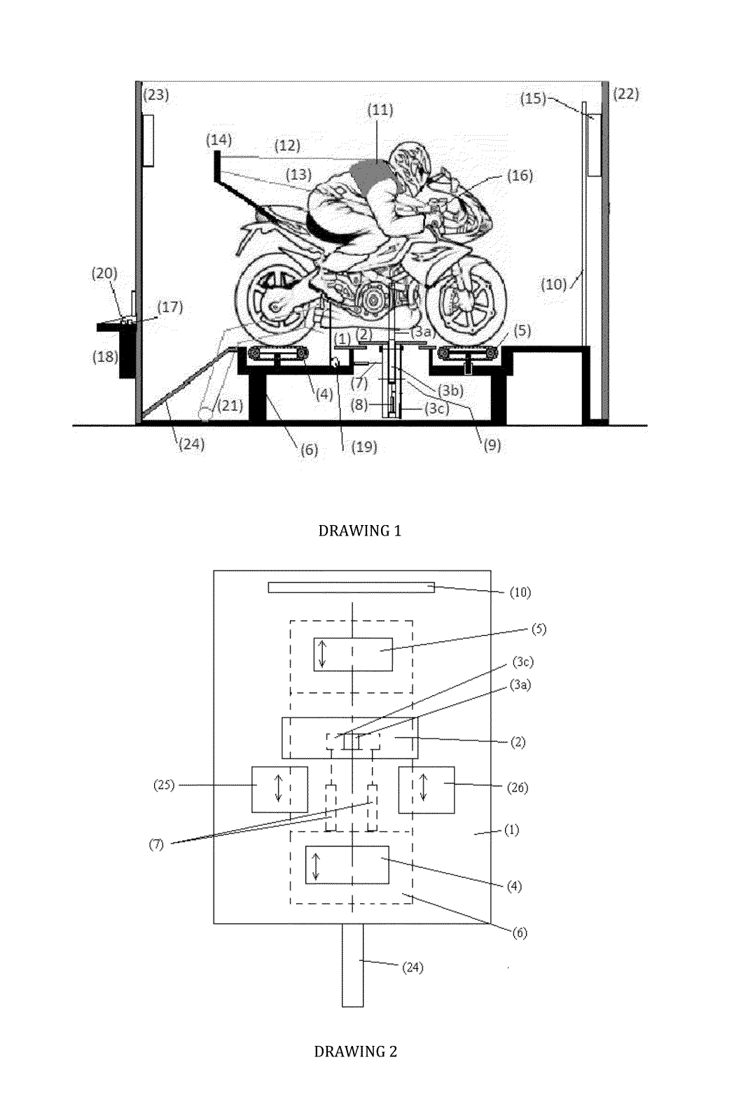

As an Alternative, as shown in FIG. 2, two lateral treadmills (25) and (26) synchronized to the speed of treadmills (4) and (5) can be added for simulating road movement in the pilot's knee zone used when tilting during race training. Also the lubrication of the treadmills (4) and (5) can be used to simulate the different adhesion conditions.

Simulation's protocol can allow several choices of use depending of needs expressed by the user, by way of non-limiting example:

A driving without any constraint, the device behavior is only constrained by the predetermined end limits and security policy.

A driving without any exceptional behaviors of the vehicle, all driving errors are attenuated by the device.

A learning driving limiting certain selected parameters.

A driving conducted in a selected mode that includes an abnormal particular constraint.

Selected sequence repeated

Suppression or addition of side, front or rear wind or combination of several directions.

Removing or adding acceleration sensations and braking or one of the two.

Selecting visualization mode on the screen as well as simulation choice.

Modifying the desired ideal trajectory.

Prediction of the path followed by the vehicle.

By way of non-limiting example, the device will have dimensions of the order of 4 meters in width, 6 meters in length and 2.7 meters high.

The inventive device is particularly for teaching and improving driving skill on a two-wheeled vehicle. Thanks to its capability to rendering the real behavior of a vehicle in the different configurations of taxiing like they can exist outdoors, it can be used by all types of drivers for leisure as well, learning, improvement or professional intensive training but always safely.

Manufacturers and equipment suppliers can also use it for testing new equipments in having the possibility of performing dynamic measurements very simply in real use which is not always easy and sometimes even impossible on a real track.

1. Device to simulate the piloting of a two-wheeled vehicle restoring the true driving sensations characterized in that it comprises a real two-wheeled vehicle moving over two separate treadmills (4) and (5), one for the front wheel which follows the direction of the vehicle handlebar and one for the rear wheel. The different types of vehicles used are held in position on the device by a suitable rigid support (3) attached to the chassis of the vehicle. The jack (7) of this support provides the degrees of freedom necessary to enable tilting motions and contributes to the rendering of normal and abnormal behaviors of the vehicle.

2. Device according to claim 1 characterized in that the rear treadmill (4) is driven by the rear wheel of the vehicle in accordance with the simulated grip conditions, the front wheel of the vehicle being driven at the same rotational speed by the front treadmill (5) in a speed range compatible with the capabilities of current road and sport vehicles.

3. Device according to claim 2 characterized in that the distance between the rear treadmill (4) and the front treadmill (5) is adjustable to be compatible with the wheelbase of the different types of two-wheeled vehicles.

4. Device according to claim 3 characterized in that the treadmills (4) and (5) permit to measure continuously the vertical pressure exerted by each wheel on the treadmills while taxiing.

5. Device according to claim 2 characterized in that two lateral treadmills (25) and (26) synchronized to the main treadmills speed (4) and (5) may be added in the driver knee support areas used when the vehicle is tilting.

6. Device according to claim 1 characterized in that the vehicle movements and their amplitude may be enforced separately by the action of jacks (7) and (8).

7. Device according to claim 1 characterized in that it comprises a chest protector (11) worn by the driver of the vehicle to restore the sensations of acceleration and braking.

8. Device according to claim 1 characterized in that it comprises means for simulating cross, front and rear wind (15) to restore to the nearest external driving conditions.

9. Device according to claim 5 characterized in that it includes safety elements with automatic or manual release to stop all vehicle and device movements but also to protect the driver.

10. Device according to claim 1 characterized in that it comprises road or offroad route display means (10) whose size and distribution can stimulate the whole driver field of vision and wherein the representation of the path is controlled in real time to the vehicle path regardless of the settings chosen for simulation and visualization modes.
